(19) United States
(12) Patent Application Publication
(10) Pub. No.: US 2023/0219177 A1
(43) Pub. Date: Jul. 13, 2023

(54) LASER CUTTING APPARATUS

(71) Applicant: LG ENERGY SOLUTION, LTD., Seoul (KR)

(72) Inventors: Bu Won SON, Daejeon (KR); Jin Soo LEE, Daejeon (KR); Jin Yeong LEE, Daejeon (KR); Yeong Hun JUNG, Daejeon (KR); Jeong Ho PARK, Daejeon (KR)

(73) Assignee: LG ENERGY SOLUTION, LTD., Seoul (KR)

(21) Appl. No.: 18/015,750

(22) PCT Filed: Aug. 12, 2021
(86) PCT No.: PCT/KR2021/010767

§ 371 Date: Jan. 12, 2023

(30) Foreign Application Priority Data
Aug. 12, 2020 (KR) 10-2020-0101389

(51) Int. Cl. B23K 37/04; B23K 26/38; H01M 50/103; H01M 50/119

(52) U.S. Cl. CPC B23K 37/04; B23K 26/38; H01M 50/103; H01M 50/119

(57) ABSTRACT

A laser cutting apparatus includes a lower jig configured to support a lower portion of a first side of a cutting region of an object to be cut by a laser beam, an upper jig configured to support an upper portion of the first side of the cutting region of the object, a laser nozzle configured to emit the laser beam towards the cutting region of the object, and a spatter block jig locatable between a body part of the object and the cutting region of the object.

### TECHNICAL FIELD

### Cross-Reference to Related Applications

The present application claims the benefit of the priority of Korean Patent Application No. 10-2020-0101389, filed on Aug. 12, 2020, which is hereby incorporated by reference in its entirety.

### Technical Field

The present invention relates to a laser cutting apparatus, which is capable of preventing spatters, which occur during cutting, with laser beam, a product such as a battery case, splash onto the product to be contaminated, or the spatters are introduced into the product such as the battery case to cause a defect in the product.

### Background Art

Cutting a product such as a battery case using a laser means cutting a product by applying an output of laser beam. However, laser cutting means cutting a product with laser beam according to a designed shape.

In the field of a secondary battery, studies on changing an existing battery cell manufactured in the form of a pouch into a thin metal packaging or metal case are being carried out, and thus there is a need for a novel manufacturing process. In order to cut a product such as a metal packaging or a metal case, a press die is used, but there are problems in that it is difficult to process a product having a complicated shape by using the press die and in the case of a thin product, the product is damaged. Thus, the laser cutting is used to cut the product such as the thin metal packaging or metal case.

However, even in the case of the laser cutting, there have been problems that the spatters, which are metal fragments of the product melted by the laser beam in a cutting region, splash onto the product to cause the product to be contaminated, and thus a cleaning process is further needed, and in the severe case, the spatters splash into the product to cause a defect in the product.

Referring to FIG. 1, it is illustrated that laser beam I emitted from a laser nozzle N cuts a cutting region D-2 of a laser-cutting object D. The laser-cutting object D may be a thin metal battery case. In this case, spatters S, which are metallic foreign matters generated in the cutting region D-2, may splash onto a body part D-1 of the laser-cutting object D to cause contamination or a defect in the product. A region A is illustrated in a state in which the spatters S splash onto the body part D-1 of the laser-cutting object D to cause the contamination in the product. A lot of studies has been conducted in order to solve such the problems of the laser cutting.

### DISCLOSURE OF THE INVENTION

### Technical Problem

The present invention is invented to solve the above problems, and an object of the present invention is to provide a laser cutting apparatus, which is capable of preventing that spatters, which occur during cutting, with laser beam, a product such as a battery case, splash onto the product to be contaminated, or the spatters are introduced into the product such as the battery case to cause a defect in the product.

### Technical Solution

A laser cutting apparatus according to the present invention includes a lower jig configured to support a lower portion of a first side of a cutting region of an object to be cut by a laser beam, an upper jig configured to support an upper portion of the first side of the cutting region of the object, a laser nozzle configured to emit the laser beam towards the cutting region of the object, and a spatter block jig locatable between a body part of the object and the cutting region of the object.

The lower jig may include a lower recess configured to receive the body part of the object and the spatter block jig, the spatter block jig may have an inner recess region to accommodate the object, the spatter block jig being placeable inside the lower recess of the lower jig the upper jig may be configured to cover the lower jig, the upper jig may be configured to support, along with the lower jig, the upper and lower portions of the first side of the cutting region of the object to fix the object, and a circumferential wall of the spatter block jig, which defines a circumference of the inner recess region of the spatter block jig, may be disposable between the body part of the object and the cutting region of the object.

The circumferential wall of the spatter block jig may be configured to block spatter moving towards the body part of the l object in the cutting region of the object during cutting with the laser beam.

The circumferential wall of the spatter block jig may be disposable below the cutting region of the object, and an upper portion of the circumferential wall of the spatter block jig may be formed in an upwardly tapered shape.

A circumferential wall of the lower jig, which defines a circumference of the lower recess of the lower jig, may be spaced apart from the circumferential wall of the spatter block jig such that the cutting region of the object is interposable therebetween.

A portion forming an inner circumference of the upper jig may have a right triangular shape in cross-section, and a portion defining an outer circumference of the lower jig may have a quadrangular shape in cross-section.

The object may be an L-shaped metal battery case, and the inner recess region of the spatter block jig may be L-shaped.

The cutting region of the object may be located in an edge of the L-shaped metal battery case, and the upper jig and the lower jig may be configured to hold a portion outside the cutting region of the object in the edge by vertically pressing the portion.

The lower jig and the upper jig may have lower screw holes and upper screw holes in a circumferential region outside the lower recess, respectively, and the upper jig and the lower jig may be screw-coupled through the upper and lower screw holes to fix the object.

At least one spatter discharge hole may be located in a portion of the lower recess of the lower jig below the cutting region of the object.

The at least one spatter discharge hole may be a plurality of spatter discharge holes that extend along a direction in which the cutting region of the object extends.

The at least one spatter discharge hole may be a plurality of spatter discharge holes that extend adjacent a circumference of the lower recess.

### Advantageous Effects

The laser cutting apparatus according to the embodiments of the present invention may include the lower jig for supporting the lower portion of one side of the cutting region of the laser-cutting object, the upper jig for supporting the upper portion of one side of the cutting region of the laser-cutting object, the laser nozzle configured to emit the laser beam towards the cutting region of the laser-cutting object, and the spatter block jig disposed between the body part of the laser-cutting object and the cutting region, and thus may prevent that spatters, which occur during the cutting, with the laser beam, the product such as the battery case, splash onto the product to be contaminated, or the spatters are introduced into the product such as the battery case to cause the defect in the product.

### BRIEF DESCRIPTION OF THE DRAWINGS

FIG. 1 is a side view illustrating a state of performing laser cutting with a laser cutting apparatus according to a related art.

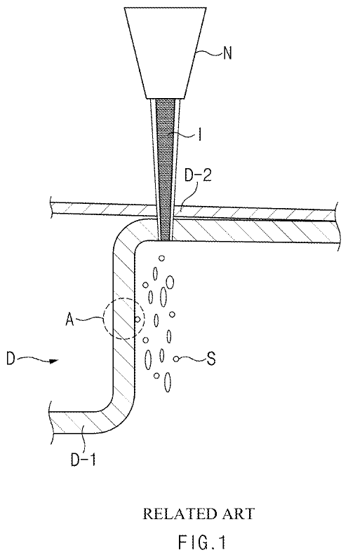

FIG. 2 is a side view illustrating a state of performing cutting with laser beam by a laser cutting apparatus according to Embodiment 1 of the present invention.

FIG. 3 is a perspective view illustrating a lower jig in a laser cutting apparatus according to Embodiment 2 of the present invention.

FIG. 4 is a perspective view illustrating a spatter block jig in the laser cutting apparatus according to Embodiment 2 of the present invention.

FIG. 5 is a perspective view illustrating an upper jig in the laser cutting apparatus according to Embodiment 2 of the present invention.

FIG. 6 is a perspective view illustrating a state in which the spatter block jig is inserted into a lower recess of the lower jig in the laser cutting apparatus according to Embodiment 2 of the present invention.

FIG. 7 is a perspective view illustrating a state in which the upper jig is coupled onto the lower jig in the view of FIG. 6.

FIG. 8 is a perspective view illustrating a laser-cutting object to be cut by the laser cutting apparatus according to Embodiment 2 of the present invention.

FIG. 9 is a side cross-sectional view illustrating a state of performing the cutting with the laser beam by the laser cutting apparatus according to Embodiment 2 of the present invention.

FIG. 10 is a perspective view illustrating a state of a product in which the cutting is completed by the laser cutting apparatus according to Embodiment 2 of the present invention.

### MODE FOR CARRYING OUT THE INVENTION

Hereinafter, preferred embodiments of the present invention will be described in detail with reference to the accompanying drawings in such a manner that the technical idea of the present invention may easily be carried out by a person with ordinary skill in the art to which the invention pertains. The present invention may, however, be embodied in different forms and not be limited or restricted to the embodiments below.

A part unrelated to the description or the detailed descriptions of related arts which may unnecessarily obscure the gist of the present invention will be omitted so as to clearly describe the present invention, and when reference symbols are added to the components of the drawings in the present specification, the identical or similar reference symbols are affixed to the identical or similar components throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

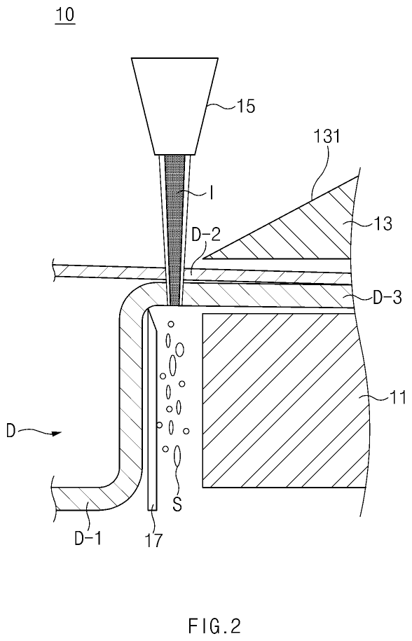

FIG. 2 is a side view illustrating a state of performing the cutting with laser beam by a laser cutting apparatus according to Embodiment 1 of the present invention.

Referring to FIG. 2, a laser cutting apparatus 10 according to Embodiment 1 of the present invention may include a lower jig 11, an upper jig 13, a laser nozzle 15, and a spatter block jig 17. The lower jig 11 and the upper jig 13 may serve to support and fix a laser-cutting object D. If the lower jig 11 and the upper jig 13 do not exist, the object may wobble during cutting the object with a laser beam I, and if the object wobbles like this, the cutting may not be performed according to a desired design. Therefore, the lower jig 11 and the upper jig 13 may fix the object in order to prevent the above problem.

The lower jig 11 may serve to support a lower portion of one side of a cutting region D-2 of the laser-cutting object D. The upper jig 13 may serve to support an upper portion of one side of the cutting region D-2 of the laser-cutting object D.

The laser nozzle 15 may be disposed above the cutting region D-2. The laser nozzle 15 may emit the laser beam I from above to below, that is, toward the cutting region D-2 of the laser-cutting object D to cut the cutting region D-2 of the object.

In this case, the laser-cutting object D may include a body part D-1 and the cutting region D-2 extending from the body part D-1. When the cutting region D-2 is cut, only the body part D-1 may remain as a product to be used.

The laser cutting apparatus 10 according to Embodiment 1 of the present invention may include the spatter block jig 17 disposed between the body part D-1 of the laser-cutting object D and the cutting region D-2.

When cutting in the cutting region D-2 by emitting the laser beam I, spatters S, which are metal fragments of a product melted by the laser beam I in the cutting region D-2, splash onto the product (the body part in the present invention) to cause the product to be contaminated, the present invention includes the spatter block jig 17 as a component which prevents the spatters S from splashing like this.

When the spatters S splash onto the laser-cutting object D, the contamination of the product may occur, and when the spatters S splash into the product, a defect in the product may occur. The spatter block jig 17 may be disposed between the cutting region D-2 and the laser-cutting object D to prevent the spatters S from splashing onto the laser-cutting object D. The spatter block jig 17 may be disposed particularly between the cutting region D-2 and the body part D-1 of the laser-cutting object D to prevent the spatters S from piling up on the body part D-1 of the laser-cutting object D. In this way, the laser cutting apparatus 10 according to Embodiment 1 of the present invention may prevent the contamination or defect of the product due to the cutting with the laser beam I.

Referring to FIG. 2, in the laser cutting apparatus 10 according to Embodiment 1 of the present invention, a portion forming the circumference of the upper jig 13 may have a cross-section in a right triangular shape, and a portion forming the circumference of the lower jig 11 may have a cross-section in a quadrangular shape.

The cross-section of the portion forming the circumference of the upper jig 13 may have a right triangular shape, and be placed so that a hypotenuse 131 of the upper jig faces the laser nozzle 15. In this case, because a space, in which the laser nozzle 15 and the laser beam I may be placed, is expanded, the cutting with the laser beam may be easily performed, and this may be great advantage in moving to various directions and positions so as to form a complicated shape. When the portion forming the circumference of the lower jig 11 has the cross-section in a quadrangular shape, a top surface of the lower jig 11 may have a flat shape and a bottom surface of the lower jig 11 may also have a flat shape, and therefore this may give the lower jig 11 a big advantage in fixing and maintaining the object stably in the lower portion.

In addition, in the laser cutting apparatus 10 according to Embodiment 1 of the present invention, the spatter block jig 17 may be disposed below the cutting region D-2, and an upper portion of the spatter block jig 17 may be formed in an upwardly tapered shape. In this case, the width of the spatter block jig 17 decreases as it goes toward the cutting region D-2, and thus this shape has an advantage to allow a lot of space in the cutting region D-2.

### Embodiment 2

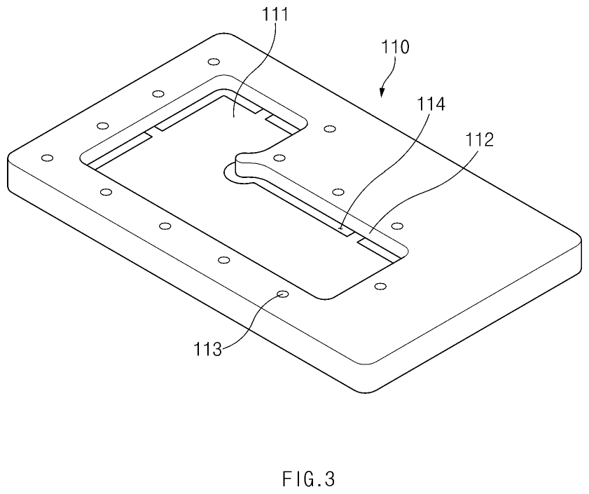

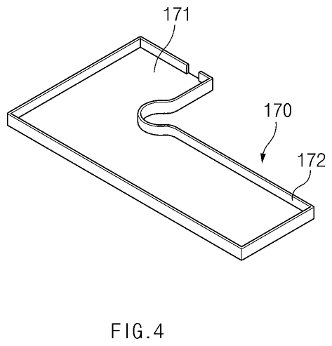

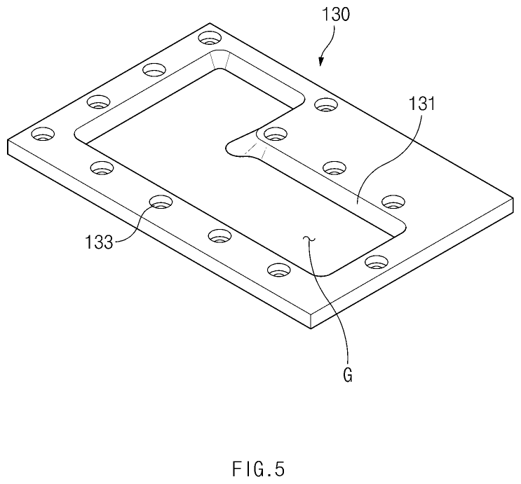

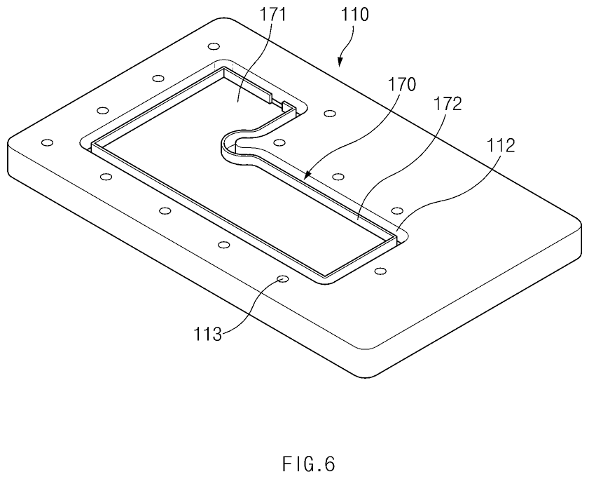

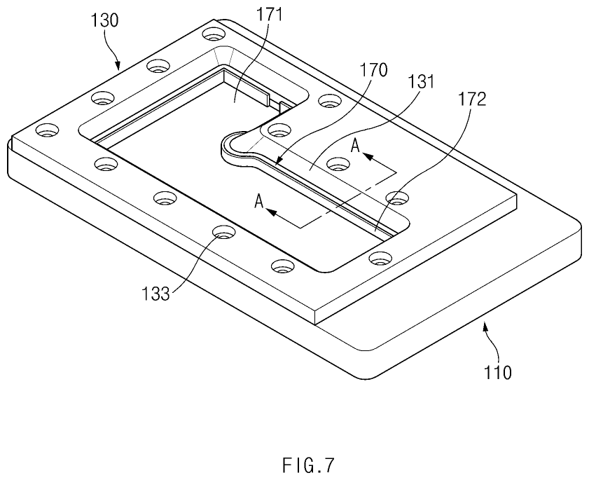

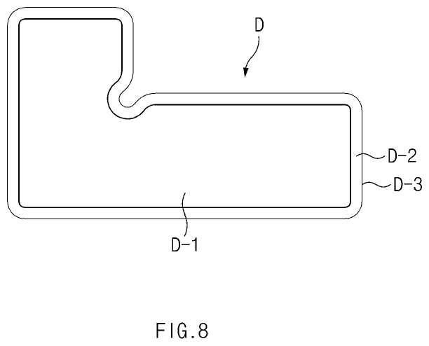

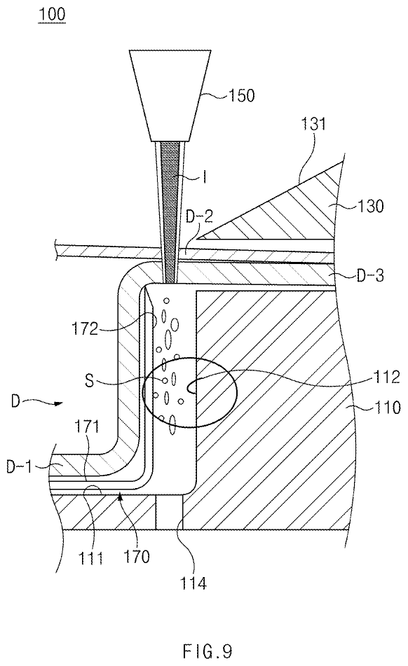

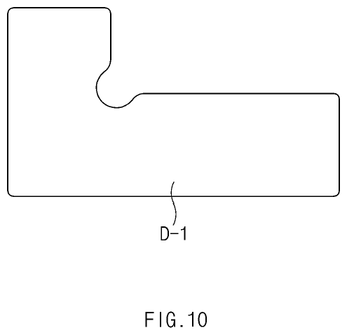

FIG. 3 is a perspective view illustrating a lower jig 110 in a laser cutting apparatus 100 according to Embodiment 2 of the present invention. FIG. 4 is a perspective view illustrating a spatter block jig 170 in the laser cutting apparatus 100 according to Embodiment 2 of the present invention. FIG. 5 is a perspective view illustrating an upper jig 130 in the laser cutting apparatus 100 according to Embodiment 2 of the present invention. FIG. 6 is a perspective view illustrating a state in which the spatter block jig 170 is inserted into a lower recess 111 of the lower jig 110 in the laser cutting apparatus 100 according to Embodiment 2 of the present invention. FIG. 7 is a perspective view illustrating a state in which the upper jig 130 is coupled onto the jig 110 in the view of FIG. 6. FIG. 8 is a perspective view illustrating a laser-cutting object D to be cut with the laser cutting apparatus 100 according to Embodiment 2 of the present invention. FIG. 9 is a side cross-sectional view illustrating a state of performing the cutting with the laser beam I by the laser cutting apparatus 100 according to Embodiment 2 of the present invention. FIG. 10 is a perspective view illustrating a state of a product in which the cutting is completed by the laser cutting apparatus 100 according to Embodiment 2 of the present invention.

In Embodiment 2 of the present invention, a laser-cutting object D may be an L-shaped metal battery case, and there may be differences from Embodiment 1 in that the laser cutting apparatus 100 may have a shape in order to cut such an L-shaped freeform shape.

The common features with Embodiment 1 will be omitted if possible, and Embodiment 2 will be described mainly focusing on differences.

Referring to FIG. 3, the lower jig 110 may be made of metal. The lower jig 110 may be provided with a lower recess 111 having a downwardly recessed shape. The lower recess 111 may be formed in an L shape in order to match the shape of the laser-cutting object D. The lower recess 111 is in the L shape, but may have a circular or curved part in a portion thereof. A circumferential wall 112 of the lower jig 110 may be formed in the circumference of the lower recess 111. Spatter discharge holes 114 may be formed outside the lower recess 111. Due to the spatter discharge holes 114, the foreign matters, spatters S, may be easily discharged and removed. Lower screw holes 113 for coupling with the upper jig 130 may be formed in the lower jig 110.

Referring to FIG. 4, the block jig for the spatters S may be formed in the L shape corresponding to the shape of the lower recess 111. In addition, the block jig may have a shape similar to the lower recess 111 of the L-shaped lower jig 110. However, the block jig may have a size smaller than that of the lower recess 111 of the lower jig 110.

An inner recess region 171 having a downwardly recessed shape may be formed in the spatter block jig 170. The laser-cutting object D may be an L-shaped metal battery case, and the spatter block jig 170 may have the L-shaped inner recess region 171. A circumferential wall 172 of the spatter block jig, which forms the circumference of the inner recess region 171, may be provided.

Referring to FIG. 5, the upper jig 130 may have an L-shaped through-hole G formed in the region corresponding to the lower recess 111 of the lower jig 110. Upper screw holes 133 for coupling with the lower jig 110 may be formed at the periphery of the through-hole.

FIG. 6 illustrates a shape in which the spatter block jig 170 is inserted and placed into the lower recess 111 of the lower jig 110. The circumferential wall 172 of the spatter block jig and the circumferential wall 112 of the lower jig 110 may be disposed at a predetermined distance. A cutting region D-2 of the laser-cutting object D may be disposed in this predetermined distance region. The spatter block jig 170 may be disposed in order not to protrude higher than the height of the lower recess 111 of the lower jig 110.

FIG. 7 is a state in which the upper jig 130 is placed to cover the lower jig 110 in the state of FIG. 6. The shape of the spatter block jig 170 is seen as it is through the L-shaped through-hole formed in the upper jig 130. The upper jig 130 and the lower jig 110 may be screw-coupled through screws that are inserted into the upper screw holes 133 and the lower screw holes 113. This may stably fix the laser-cutting object D.

FIG. 8 illustrates the laser-cutting object D. The laser-cutting object D may be a battery case made of SUS metal. The laser-cutting object D may include a body part D-1 formed in the L shape and an edge D-3 extending from the circumference of the body part D-1. A region in the edge D-3 closer to the body part D-1 may be the cutting region D-2. Except for the cutting region D-2 in the edge D-3, the upper jig 130 and the lower jig 110 may fix the object not to wobble by holding the edge D-3 positioned outside the cutting region D-2.

FIG. 9 is a cross-sectional view taken along the line A-A′ of FIG. 7, which illustrates a state of performing the cutting with the laser beam I by the laser cutting apparatus 100 according to Embodiment 2 of the present invention. FIG. 7 illustrates, however, a perspective view without the laser-cutting object D for better understanding while FIG. 9 is a cross-sectional view illustrating a state including the laser-cutting object D.

As the laser beam I emitted from the laser nozzle 150 is focused onto the cutting region D-2 of the laser-cutting object D, the cutting with the laser beam I is carried out. In the cutting region D-2, the spatters S splash downwardly, and in this case, it may be seen that the circumferential wall 172 of the spatter block jig serves to block the splashed spatters, thereby protecting the laser-cutting object D (particularly, protecting the body part). The circumferential wall 172 of the spatter block jig may be disposed between the body part D-1 of the laser-cutting object D and the cutting region D-2. In addition, the circumferential wall 172 of the spatter block jig may be disposed between the body part D-1 of the laser-cutting object D and the circumferential wall 112 of the lower jig 110.

Specifically, referring to FIGS. 3 to 9, in the laser cutting apparatus 100 according to Embodiment 2 of the present invention, the lower jig 110 may be provided with the lower recess 111. The lower recess 111 may be formed in a downwardly recessed shape for inserting the body part D-1 of the laser-cutting object D and the spatter block jig 170.

The spatter block jig 170 may also have the inner recess region 171 in a downwardly recessed shape. In the inner recess region 171 of the spatter block jig, the body part D-1 of the laser-cutting object D may be accommodated. The spatter block jig 170 may be placed inside the lower recess 111 of the lower jig while accommodating the body part D-1 of the laser-cutting object D in the inner recess region 171.

The upper jig 130 may cover the lower jig 110, and support, along with the lower jig 110, upper and lower portions of one side of the cutting region D-2 of the laser-cutting object D to fix the laser-cutting object D, and the circumferential wall 172 of the spatter block jig, which forms the circumference of the inner recess region 171 of the spatter block jig 170, may be disposed between the body part D-1 of the laser-cutting object D and the cutting region D-2.

Through this shape, the circumferential wall 172 of the spatter block jig may block spatters S (metal foreign matters) in the middle of flight towards the body part D-1 of the laser-cutting object D in the cutting region D-2 during performing the cutting with the laser beam I.

In the laser cutting apparatus 100 according to Embodiment 2 of the present invention, the circumferential wall 172 of the spatter block jig may be disposed below the cutting region D-2, and an upper portion of the circumferential wall 172 of the spatter block jig may be formed in an upwardly tapered shape. In this case, the width of the circumferential wall 172 of the spatter block jig decreases as it goes toward the cutting region D-2, and thus this shape has an advantage to allow a lot of space in the cutting region D-2.

The circumferential wall 112 of the lower jig, which forms the circumference of the lower recess 111 of the lower jig 110, is spaced from the circumferential wall 172 of the spatter block jig with the cutting region D-2 interposed therebetween, and the spatters S may be discharged through this spaced space therebetween. These discharged spatters S may be discharged through the spatter discharge holes 114. That is, the spatter discharge holes 114 are formed in a part below the cutting region D-2 in the lower recess 111 of the lower jig, and thus the spatters S may be easily removed. The spatter discharge holes 114 may extend along the direction in which the cutting region D-2 extends (i.e., the direction following the circumference of the lower recess), and be formed in plurality. When the spatter discharge holes are formed in plurality over the whole region, the spatter may be removed more smoothly.

The cross-section of the portion forming the circumference of the upper jig 130 may have a right triangular shape, and be placed so that a hypotenuse 131 of the upper jig faces the laser nozzle 150. In this case, because a space, in which the laser nozzle 150 and the laser beam I may be placed, is expanded, the cutting with the laser beam I may be easily performed, and this may be great advantage in moving to various directions and positions so as to make a complicated shape. When the portion forming the circumference of the lower jig 110 has the cross-section in a quadrangular shape, the top surface of the lower jig 110 may have a flat shape and the bottom surface of the lower jig 110 may also have a flat shape, and therefore this may give the lower jig 11 a big advantage at fixing and maintaining the object stably in the lower portion.

Referring to FIG. 9, when the laser-cutting object D is an L-shaped metal battery case, the cutting region D-2 is formed on the edge D-3 of the L-shaped metal battery case, and the upper jig 130 and the lower jig 110 may hold a portion disposed outside the cutting region D-2 in the edge D-3 by vertically pressing the portion.

The lower jig 110 and the upper jig 130 may have the lower screw holes 113 and the upper screw holes 133, respectively, in the circumferential region at the circumference of the position in which the object of the laser beam I is placed, and be screw-coupled through the upper screw holes 133 and the lower screw holes 113 so as to fix the laser-cutting object D.

The laser cutting apparatus 100 according to Embodiment 2 of the present invention has significance in that the laser cutting apparatus 100 may be constituted in more various and realized forms than the laser cutting apparatus 100 according to Embodiment 1. In Embodiment 2 of the present invention, the laser-cutting object D may be the L-shaped metal battery case, and accordingly, the lower jig 110, the upper jig 130, and the spatter block jig 170 of the laser cutting apparatus 100 may have a shape in order to cut such an L-shaped freeform shape.

Therefore, the present invention may neatly perform the cutting with the laser beam I by protecting the spatters S while stably supporting various shapes including the L-shape.

Although the present invention is described by specific embodiments and drawings, the present invention is not limited thereto, and various changes and modifications may be made by a person skilled in the art to which the present invention pertains within the technical idea of the present invention and equivalent scope of the appended claims.

[Description of the Symbols]
10, 100: Laser cutting apparatus
11, 110: Lower jig
111: Lower recess
112: Circumferential wall of lower jig
113: Lower screw hole
114: Spatter discharge hole
13, 130: Upper jig
131: Hypotenuse of upper jig
133: Upper screw hole
15, 150: Laser nozzle
17, 170: Spatter block jig
171: Inner recess region
172: Circumferential wall of spatter block jig
S: Spatter
D: Laser-cutting object
D-1: Body part
D-2: Cutting region
D-3: Edge
I: Laser beam

1. A laser cutting apparatus comprising:
a lower jig configured to support a lower portion of a first side of a cutting region of an object to be cut by a laser beam;
an upper jig configured to support an upper portion of the first side of the cutting region of the object;
a laser nozzle configured to emit the laser beam towards the cutting region of the object; and
a spatter block jig locatable between a body part of the object and the cutting region of the object.

2. The laser cutting apparatus of claim 1, wherein the lower jig comprises a lower recess configured to receive the body part of the object and the spatter block jig,
wherein the spatter block jig has an inner recess region to accommodate the object, the spatter block jig being placeable inside the lower recess of the lower jig,
wherein the upper jig is configured to cover the lower jig, the upper jig being configured to support, along with the lower jig, the upper and lower portions of the first side of the cutting region of the object to fix the object, and
wherein a circumferential wall of the spatter block jig, which defines a circumference of the inner recess region of the spatter block jig, is disposable between the body part of the object and the cutting region of the object.

3. The laser cutting apparatus of claim 2, wherein the circumferential wall of the spatter block jig is configured to block spatter moving towards the body part of the object in the cutting region of the object during cutting with the laser beam.

4. The laser cutting apparatus of claim 3, wherein the circumferential wall of the spatter block jig is disposable below the cutting region of the object, and
wherein an upper portion of the circumferential wall of the spatter block jig is formed in an upwardly tapered shape.

5. The laser cutting apparatus of claim 2, wherein the circumferential wall of the lower jig, which defines a circumference of the lower recess of the lower jig, is spaced apart from the circumferential wall of the spatter block jig such that the cutting region of the object is interposable therebetween.

6. The laser cutting apparatus of claim 2, wherein a portion forming an inner circumference of the upper jig has a right triangular shape in cross-section, and
wherein a portion defining an outer circumference of the lower jig has a quadrangular shape in cross-section.

7. The laser cutting apparatus of claim 2, wherein the object is an L-shaped metal battery case, and
wherein the inner recess region of the spatter block jig is L-shaped.

8. The laser cutting apparatus of claim 7, wherein the cutting region of the object is located in an edge of the L-shaped metal battery case, and
wherein the upper jig and the lower jig are configured to hold a portion outside the cutting region of the object in the edge by vertically pressing the portion.

9. The laser cutting apparatus of claim 2, wherein the lower jig and the upper jig have lower screw holes and upper screw holes in a circumferential region outside the lower recess, respectively, and
wherein the upper jig and the lower jig are screw-coupled through the upper and lower screw holes to fix the object.

10. The laser cutting apparatus of claim 2, wherein at least one spatter discharge hole is located in a portion of the lower recess of the lower jig below the cutting region of the object.

11. The laser cutting apparatus of claim 10, wherein the at least one spatter discharge hole includes a plurality of spatter discharge holes that extend along a direction in which the cutting region of the object extends.

12. The laser cutting apparatus of claim 10, wherein the at least one spatter discharge hole includes a plurality of spatter discharge holes that extend adjacent a circumference of the lower recess.
